(19) United States
(12) Patent Application Publication
(10) Pub. No.: US 2024/0316678 A1
(43) Pub. Date: Sep. 26, 2024

(54) WELDED ASSEMBLY AND METHOD OF WELDING USING ELECTRO-SPARK DISCHARGE

(71) Applicant: HUYS INDUSTRIES LIMITED, Weston (CA)

(72) Inventors: Peng PENG, Kitchener (CA); Yunhong Norman ZHOU, Waterloo (CA); Jihui YAN, Waterloo (CA)

(21) Appl. No.: 18/606,672

(22) Filed: Mar. 15, 2024

Related U.S. Application Data
(60) Provisional application No. 63/491,771, filed on Mar. 23, 2023.

(51) Int. Cl. B23K 9/30; B22F 1/00; B23K 9/022

(52) U.S. Cl. CPC B23K 9/30; B22F 1/09; B23K 9/022

(57) ABSTRACT

A method of surface treatment of an electrically conductive workpiece includes applying a powder coating to the workpiece in a green state before being welded to the workpiece using ESD. The coating is a heterogenous mixed powder of electrically conductive particles. It may be a High Entropy Alloy having at least five elements, each being 5% to 35% atomic fraction of the mixture. The welding occurs at contacts of less than 10 J. The powder may be formed as a slurry, whether in an aqueous solution or with a binder; and may be applied as a slurry or as a paste. It may be applied to non-flat and non-horizontal surfaces. Once deposited, it may be peened after ESD arcing. The ESD applicator may use a welding rod that is of a different material from either the powder mixture or the workpiece.

### CROSS-REFERENCE TO RELATED APPLICATIONS

The present invention claims the benefit of U.S. Provisional Patent Application No. 63/491,771, filed Mar. 23, 2023, which is incorporated by reference herein in its entirety.

### FIELD OF THE INVENTION

This specification relates to the field of welding using electro-spark discharge (ESD).

### BACKGROUND

In some processes it may be desired to make a weld without significant alteration of the grain structure of one or the other, or both, of the parts being joined together. It may be that the parts to be joined, when welded, may yield precipitated secondary or tertiary compounds from alloyed elements otherwise in solution in at least one of them. Those compounds may have undesirable properties; or may simply detract from the properties for which the joined elements were desired to be combined in the first place. It may involve undesired precipitation, or loss of age hardening, or loss of shape-memory abilities, or undesired alloys such as oxides. There may be other reasons.

One approach to this problem may be to pre-coat one or other of the parts with an intermediate layer of a weld metal element or alloy, particularly where direct welding of the parts together may be difficult either for metallurgical or process limitation reasons. For example, one or other of the parts may be a sintered part, or may be a part with a metallic ceramic coating. Such parts can be difficult to weld or to machine. In some instances, an alloy such as nickel may be friendly to both parts to be welded and so a layer, or layers, of such an alloy may be built up on one or the other of the parts. It may be termed an intermediate layer, or, more simply, an “interlayer”. Further, where it is desired not to upset the pre-welded grain structure or heat treatment of one or another of the parts, it may be desirable to perform such preliminary steps, and possibly the weld itself, with a low energy input. To that end, the present inventor has considered the possibilities of using Electro-spark discharge (ESD) welding for one or more steps in such a process as discussed herein.

In each process, the manufactured part may be made of a material where either the geometry of the part or the nature of the material itself may make post-formation machining problematic. However, notwithstanding that a molding, sintering, or cumulative printing process may yield a part that is near-net-size, and that may have material properties that may be difficult to obtain in a machined part, a weld to another object may nonetheless be desired.

Electro-Spark Discharge is a process by which the surface of an object may be treated or coated with a deposited material. The work piece is electrically conductive. One terminal of an electrical discharge apparatus is connected to the work piece (or to a fixture in which the work piece is held), and a moving electrode holder is used to cause an electrode to approach the work piece, and for material from the electrode to be deposited on the work piece when an electrical arc passes between the electrode tip and the work piece. In this process the electrode is consumed, bit-by-bit. As the process recurs repeatedly, the surface of the work piece is progressively covered, or coated in the deposited material. The deposited material is fused to the work piece surface.

### SUMMARY OF THE INVENTION

In an aspect of the invention there is a method of treatment of an electrically conductive work piece using Electro-Spark Discharge (ESD) welding. The method includes coating a first region of the workpiece with a powder composition of electrically conductive particles, the powder composition being in a green state; and using an ESD applicator to weld the composition to the workpiece.

In a feature of that aspect, the method includes obtaining powders of at least a first material and a second material; mixing those powders together; and applying the mixture of powders to the workpiece. In another feature, the method includes preparation of a High Entropy Alloy mixture. In another feature, the method includes preparation of a powder mixture in which there are more than two principal elements. In still another feature the method includes preparation of a powder mixture in which no element has an atomic fraction greater than 35%. In yet another feature, the method includes preparation of a powder mixture of at least three elements, each of those elements having an atomic fraction of 5%-35%. In a further feature, the method includes preparation of a powder mixture of an alloy of at least five elements, and in which each of the at least five elements has an atomic fraction of 5-35%.

In another feature, the method includes forming the powder composition into a slurry. In a further feature, the method includes applying the slurry to the workpiece and allowing the slurry to dry on the workpiece in the green state prior to ESD processing. In still another feature, the method includes combining the powder composition and a carrier. In an additional feature, the carrier is an aqueous liquid. In another additional feature, the carrier is a binder. In still another feature, the method includes applying the powder composition to the work piece and then allowing the binder to set. In yet another feature, the method includes depositing successive layers of green material on the workpiece.

In still another feature, the ESD applicator employs a welding rod of a material that is different from the powder composition. In another feature, the ESD applicator employs a welding rod of a material that is different from the workpiece. In still another feature, the method includes conducting ESD processing of the workpiece with electrical discharges of less than 10 Joules per contact. In still another feature, the method includes conducting ESD processing at an ESD contact frequency of 10 to 10,000 Hz. In another feature, the frequency is in the range of 1500 to 5000 Hz. In an additional feature, the method includes vibrating the workpiece during ESD processing independently of any vibration of the ESD applicator. In a further additional feature, the method includes ultrasonic vibration of at least one of (a) the workpiece; and (b) the ESD applicator. In still another feature, the method includes peening. In yet another feature, the method includes reversing polarity of the workpiece and the ESD applicator.

These and other aspects and features of the invention may be understood with reference to the description and drawings that follow.

### BRIEF DESCRIPTION OF THE DRAWINGS

FIG. 1 is a simplified isometric view showing schematically the elements of Electro-Spark Discharge (ESD) apparatus employed in implementing aspects and features of the invention herein;

FIG. 2 is an enlarged, not-to-scale conceptual illustration of the relationship of the welding rod of the ESD apparatus of FIG. 1 as it interacts with a workpiece; and

FIG. 3a is a conceptual top view of the workpiece of FIGS. 1 and 2;

FIG. 3b is a conceptual end view of the workpiece of FIG. 3a;

### DETAILED DESCRIPTION

The description that follows, and the embodiments described therein, are provided by way of illustration of an example, or examples, of particular embodiments of the principles, aspects or features of the present invention. These examples are provided for the purposes of explanation, and not of limitation, of those principles and of the invention. In the description, like parts are marked throughout the specification and the drawings with the same respective reference numerals. The drawings are substantially to scale, except where noted otherwise, such as in those instances in which proportions may have been exaggerated to depict certain features. Schematic illustrations and flowcharts, if used, are understood to be not to scale. In that regard, this description pertains to the deposition of a layer or multiple layers of a welded coating by Electro-Spark Discharge. In general, these layers tend to be of the order of a few tens of μm thick, e.g., 20 μm to 200 μm, and may tend not to exceed 2 mm in thickness. Accordingly, the thicknesses shown in the layers and the fillets of the various illustrations may be greatly exaggerated for the purposes of conceptual understanding.

It is possible to make other embodiments that employ the principles of the invention and that fall within the following claims. To the extent that the features of those examples are not mutually exclusive of each other, the features of the various embodiments may be mixed-and-matched, i.e., combined, in such manner as may be appropriate, without having to resort to repetitive description of those features for each possible combination or permutation. The invention is not limited to the specific examples or details given by way of illustration herein, but only by a purposive interpretation of the claims to include equivalents under the doctrine of equivalents.

The terminology used herein is thought to be consistent with the customary and ordinary meanings of those terms as they would be understood by a person of ordinary skill in the Electro-Spark Deposition (ESD) industry in North America. Following from Phillips v. AWH Corp., the Applicant expressly excludes all interpretations that are inconsistent with this specification, and, in particular, expressly excludes any interpretation of the claims or the language used in this specification such as may be made in the USPTO, or in any other Patent Office, other than those interpretations for which express support can be demonstrated in this specification or in objective evidence of record in accordance with In re Lee, (for example, earlier publications by persons not employed by the USPTO or any other Patent Office), demonstrating how the terms are used and understood by persons of ordinary skill in the art, or by way of expert evidence of a person or persons of at least 10 years' experience in the ESD industry in North America.

The wording used herein is intended to include both singular and plural where such would be understood, and to include synonyms or analogous terminology to the terminology used, and to include equivalents thereof in English or in any language into which this specification many be translated, without being limited to specific words or phrases. In this specification, the commonly used engineering terms “proud”, “flush” and “shy” may be used to denote items that, respectively, protrude beyond an adjacent element, are level with an adjacent element, or do not extend as far as an adjacent element, the terms corresponding conceptually to the conditions of “greater than”, “equal to” and “less than”.

This description may use multiple nouns to provide nomenclature for the features. The multiple nouns are used as synonyms, and the detailed description is used as a thesaurus to convey understanding at both the specific level and at the broader conceptual level. English often has many words for the same item, and where multiple terminology is provided, it is intended to show that synonyms for the item are within the understanding of the feature, and that it is not limited to one particular noun but is intended to include synonyms.

Electro-spark deposition (ESD) is a micro welding process that employs short duration electrical pulses to deposit electrode materials onto metallic substrates. ESD may be used to repair damaged high value precision products or to modify surfaces to increase wear and the corrosion resistance or to obtain other properties. ESD has wide applications in a broad range of aerospace, defense, automotive, and medical manufacturing activities. ESD may permit the formation of metallurgically-bonded coatings, or surface layers, yet may tend to do so with low and highly localized heat input to the workpiece. This metallurgically-bonded layer forming process is a fusion, or welding, process, as distinct from a mechanically bonded discrete surface layer such as may be produced with thermal spraying, such as a plasma spraying process, in which melted particles are blown at a cold, non-melted surface.

In a conventional weld, the heating in the molten weld fillet raises the temperature of the parent material in the heat affected zone (HAZ) of the weld. That may tend to change the physical properties of the heat affected zone, and may cause alloyed elements that had been in solution to coalesce and precipitate. By contrast, the low local energy input of ESD may tend not to change the composition or dispersion of alloying elements in the underlying matrix of the body of the object more generally, and, consequently, may tend not to change the bodily extensive properties of the substrate material.

The apparatus shown and described herein may be employed for processes that may be termed “Low Energy Welding”. For example, the heating in a resistance-welded spot weld may be of the order of about 1 kJ of energy per spot weld. By contrast, in an intermittent electrical discharge weld, as in ESD, the amount of energy used in heating at each contact of the electrode to the workpiece may be of the order of 1 Joule. The heating has very short time duration, is highly localised, and results in the deposition of only a very small amount of material. While the welding is true welding in terms of the fusion of materials through melting, the small energy input tends to reduce or substantially to eliminate any heat affected zone.

ESD may tend to occur while the workpiece is located in an ambient temperature environment, and, other than at the highly focused location of application it may occur while the body of the part being treated is at ambient temperature, or approximately ambient temperature. In context, “approximately ambient” might be considered to be from −40 C to 250 C, where the upper end of “room temperature” is still many hundreds of Kelvins (if not more than a thousand Kelvins) below the melting point of the material matrix, and well below its softening temperature, and the temperatures at which alloying elements in the matrix generally may be inclined to precipitate of coalesce.

Further, an ESD coating may be applied to only particular portions of the surface of an object, and may be applied to components with complex shape. Moreover, the procedure may be carried out at ambient room temperature conditions, and may be carried out wherever it would also be possible to carry out a stick welding procedure. Modification of stainless steel surface by electro-spark deposition may open new opportunities for improving wear and corrosion resistance of, for example, stainless steel. It may expand the applications of stainless steel and reduce the cost for materials in marine and handling of brines applications.

ESD processes may tend to permit types of materials to be welded together that might otherwise be difficult or impossible to weld together. However ESD permits a true fusion connection to be made at the atomic level. In some circumstances, though, a limiting factor in the use of ESD surface coating processes is the ability to prepare the sintered welding rods used in ESD. Some materials sinter together well. Other materials are more challenging.

For example, it is known to use welding rods of a single material to lay down a layer of a single material on a substrate. It is known to lay down nickel on steel or copper. It is known to lay down a layer of silver or molybdenum, and so on. It is also known to make welding rods of binary composite materials such as Titanium Carbide to permit copper to be coated with a ceramic coating.

However, there may be multiple constituent mixtures that one may wish to use. In the general case, it may be any material of more than two components that might yield desired properties may not be suitable for sintering into a welding rod. One example of such a material may be a “High Entropy Alloy” of HEA. In this description, a High Entropy Alloy is defined as an alloy with five and more elements and with an atomic fraction of 5-35% of all elements. This is different from a conventional metal that has only one principal element, while the HEA consist of five or more principal elements. The elemental composition of HEA is intuitive, theoretically, the alloy has the highest mixed entropy when the respective atomic fractions of the elements are equal, e.g., AlCrFcCoNi, CrFcCoNiMn and so on. This provides a greater convenience for manufacturing HEA.

The surface of any given workpiece may most frequently be exposed to the external ambient environment, which makes the surface vulnerable to different environmental influences, such as oxidation, corrosion, and other negative influences, and therefore the need to study the manufacture of high-strength coatings. The environmental influences may vary according to circumstances. A low-energy welding technique, electrospark deposition (ESD), is used to manufacture various types of metallic coatings from electrodes made of coating materials, which are melted, transferred, and solidify onto the workpiece by discharges to form the coating. However, the cost of the materials and fabricating of the electrodes may have an impact on the study of some special metals. In that circumstance, there is an opportunity to employ electrospark powder deposition (ESPD) in the manufacture of HEA coatings. The principle is similar to the conventional technique, here the discharges melt the powder rather than the electrode, and the molten powders are mixed, and solidify as an alloy.

That is, according to one process, there is a workpiece 20 that is to be provided with a surface coating over some surface area A₁. Workpiece 20 is an electrically conductive materials such as a metal or metal alloy. Generically, surface area A₁ may be the entire surface of the workpiece, or it may be one entire face of workpiece 20, or it may be one or more portions of a face. Surface area A₁ may also be just one of two or more discrete areas A₁, A₂, . . . . Aₙ (where n is however many discrete coated areas there may be).

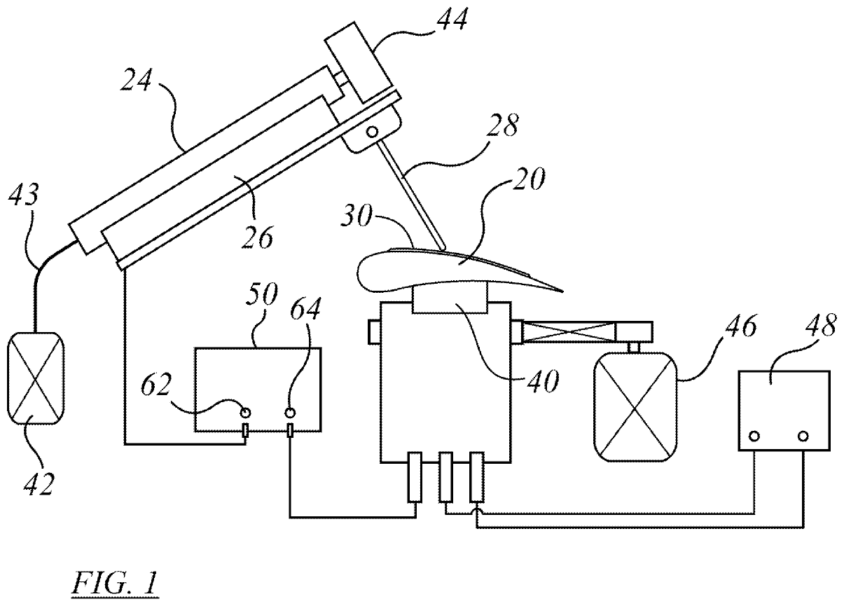

A powder mixture may be prepared using the respective constituents amounts of the identified coating material. Generally, the powder may have two or more constituent component powders. Those constituent powders may be materials that may otherwise be difficult to weld together, or difficult to weld to the parent materials of workpiece 20. The materials of the powder are individually and collectively electrically conductive and are understood to be metal or metal alloys such as may be melted with an electric arc. That powder may include more than four constituent powders that have been mixed mechanically together. That mixture may be an High Entropy Alloy. Once the component powders have been mixed, a liquid carrier may be added, and the powder may be stirred in the carrier to form a slurry 30. The carrier may be an aqueous carrier, such as water, or a solution of water such as a soap, or brine, or glue, and so on, that can be fully evaporated by heating. In the example conceptually illustrated in FIG. 1, particles of five constituent elements are shown in greatly exaggerated size, and are indicated as 31, 32, 33, 34, and 35. Whether there are more or less than 5 components, the drawing is intended to convey that the particles have been randomly mixed so that, overall, the elements are of evenly distributed concentration in slurry 30 (or, where the constituents are not of equal amounts, then distributed in concentrations proportional to the various overall amounts, be it twice as much, three times as much, or as may be).

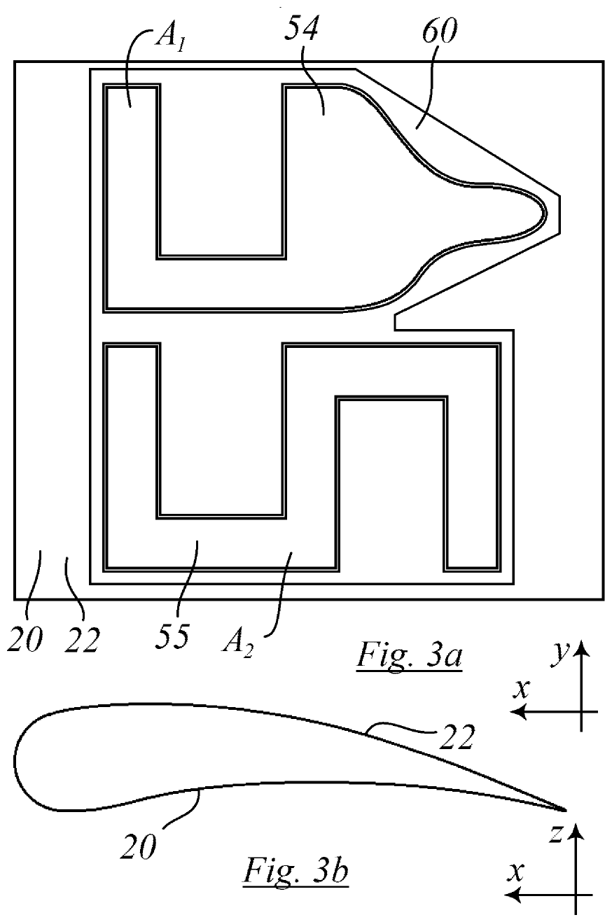

Slurry 30 may include a binder. The binder may be a binder such as used in powder metallurgy to hold metallic particles together in a green state as formed or molded and prior to sintering. Such binders may include a butane polymer having a boiling point in the range of 50 C to 85 C. Alternatively it may include a methacrylic acid polymer having a weight-average molecular weight of 1,000,000 or less, as discussed in US Publication 2015 0 361 255 of Ito et al., and in particular including the compositions identified as No. 1 to No. 40 at paragraphs [0096] to [0117] thereof. Such a binder is liquid at modest temperatures and holds the mixture of metallic particles in suspension. The wax in the binder will wet a metallic surface and thereby permits the slurry to be painted on the workpiece. The wetting (i.e., surface adhesion) of the binder to the surface permits application to non-horizontal surfaces as in the non-planar non-horizontal surface areas such as A₁ and A₂ in FIGS. 3a and 3b, upon which the slurry, or paste, may cool and dry, such that the binder may “set”. In some instances, the workpiece may be warmed modestly cither to encourage the binder to set or dry, or to encourage the binder (or aqueous or volatile portions of the binder) to evaporate off, leaving the deposited metal particle mixture. The resulting layer of deposited particles may be quite thin—of the order of magnitude of a thickness of a coat of paint, which is to say of the order of 50-200 microns, or 5 to 10 thousandths of an inch, or perhaps less. This is comparable to a typical ESD coating thickness of the deposition of a layer or multiple layers of a welded coating by electro-spark discharge. In general, these layers tend to be of the order of a few tens of μm thick, e.g., 20 μm to 200 μm, and may tend not to exceed 2 mm in thickness. In one example, the alloyed surface thickness varies from 5 μm to 80 μm depending on the electro-spark deposition parameters. Accordingly, the thicknesses shown in the layers and the fillets of the various illustrations may be greatly exaggerated for the purposes of conceptual understanding.

In terms of process context, FIG. 1 shows a first member to be welded, identified as a workpiece 20. The surface of workpiece 20 to which a coating is to be applied is identified generically as a substrate 22. This nomenclature of a “substrate” is intended to refer to any first object to be welded, whether it is flat or curved, thin or thick, whatever its profile may be, and whatever appearance it may have in plan form. In that context “substrate” is intended to be generic, unless indicated otherwise. In the illustrations of FIG. 1 and in the end view of FIG. 3b the profile is shown to be that of an airfoil, which may be a wing, and could be a turbine blade or vane such as used in a gas turbine or a compressor blade. It could also be a cam, a rocker, a valve seat, or many other objects where a surface treatment may be applied to obtain particular properties. Whatever workpiece 20 may be, there is a “green” layer or covering, or stratum, or deposition, in which the slurry or powder 30 is given the nomenclature coating 30. I.e., at this point slurry 30 is on substrate 22 as a dried powder coating. The nomenclature “coating is likewise intended to be generic. Coating 30 has two states. The first state is the “green” state in which the powder has been deposited on the surface as a slurry or paste 36. The second state is the “cured” or fused state 38 after the deposited powder has been subject to an electro-spark discharge (ESD) process using an ESD welding applicator.

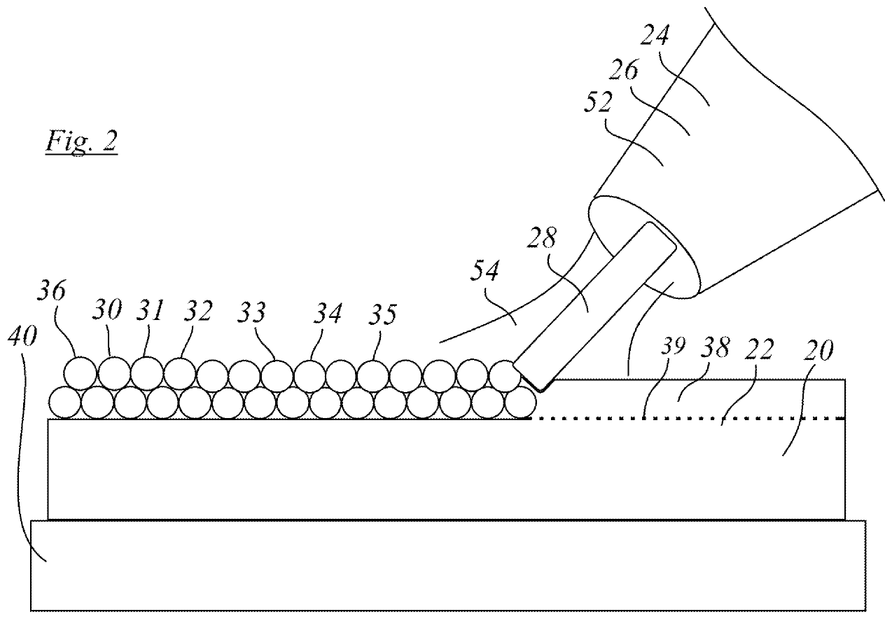

As may be understood, the thickness shown in FIG. 2 are greatly exaggerated for the purposes of illustration. The dashed line 39 is intended to represent coating 30 as fused to the base metal of substrate 22 where the welding process caused the materials to blur together The slurry is be applied to the surface area A₁ to be coated. The slurry 30 may then be dried in place by evaporating the binder, such that the surface is dusted or encrusted with residue of solids as a “green” powder. Once the dried slurry 30 has been established on A₁ (and such other to-be-coated areas as may be) the workpiece is held in position on a workpiece table, or jig, or bed, identified as workpiece holder 40 that is opposed by a welding head 50.

One kind of ESD welding applicator is indicated conceptually in FIG. 2. The Applicator is indicated generally as 24. It may be a hand-held applicator, or, as shown in FIG. 1, it may be a robot. It may have the form and function of any of the applicators shown in U.S. Pat. No. 11,077,516 of Scotchmer et al., which is incorporated by reference herein. It includes an assembly that is identified as a welding handle or welding head 26 to which an electrode, i.e., a welding rod, 28 is mounted. In this specification the terms “electrode” and “welding rod” are used interchangeably in respect of item 28. Electrode 28 is a commercially available sintered welding rod of a suitable selected composition. It may be of the same composition as the base metal of workpiece 20, or it may be of some other composition. It may, for example, be nickel or an alloy of nickel. It may generally not be the same alloy as the composition of powder coating 30. It may have been chosen to be compatible with that composition. Many kinds of electrodes may be obtained according to the materials to be welded together. A nickel electrode may weld to many other types of metals or metal alloys. Electrode 28 is a consumable welding rod that is held in the handle or fixture of applicator 24. Whether hand-held or held by a robot, the term “electrode” is also intended to be generic. Where the applicator is a robot, or is held by a robot, the robot may be programmed to interact with the deposited green powder 36 of slurry 30 and workpiece 20 according to a particular pattern or footprint A₁, A₂, etc., of substrate 22. Welding rod 28 held by applicator 24 may be of constant diameter, and may in some instances be of relatively small diameter, such as a few millimeters, e.g., 1.5 mm, 1.8 mm, and so on. It may rotate about its own longitudinal axis in use. When welding rod 28 is consumed, it is replaced with a new consumable welding rod. The composition of welding rod 28 is chosen to suit the application.

Workpiece 20 is electrically conductive. Workpiece 20 is mounted in workpiece holder 40, which is also electrically conductive. There is an ESD power supply 50. Power supply 50 is connected to a main source of electricity, be it a generator of a power main. It provides welding power discharges. Workpiece holder 40 is connected to one side of power supply 50, and accordingly, when current flows workpiece holder 40, and therefore workpiece 20, has an electrical polarity. Welding head 24 is also connected to power supply 50 and, in operation, has the opposite polarity to workpiece holder 40.

By the nature of the ESD deposition process, applicator 24 is subject to vibration, whether due to a mechanical oscillator 42 such as a rotating or reciprocating imbalance weight, or due to an ultrasonic vibrator 44, or both. The voltage of discharge, the frequency of discharge and the duration of discharge or the capacitance of the discharge of power supply 50, or all of them, are parameters that are subject to adjustment and selection according to the materials to be welded, and the thickness of coating to be applied. In the process of fusing coating 30, vibration may also be applied to the surface defined as substrate 22, whether or not welding applicator 24 is in contact with it. In the example shown, motion, including vibration, is imparted to workpiece 20, and thereby to substrate 22 by a vibration drive which may be either an oscillator 46 or an ultrasonic vibration driver 48, or both, as may be. It may be understood that the frequency of rotation of welding rod 28 will generally be different from the frequency of the forcing function of oscillator 42 or of ultrasonic vibrator 44, and, likewise, those frequencies may generally be different from the frequencies of oscillator 46 and of ultrasonic vibrator 48, such as may be. Welding may occur with or without shielding gas a shielding gas cowl or diffuser is indicated schematically in FIG. 2 as 52, and the shielding gas is indicated notionally as 54. The shielding gas may be a noble gas. In the processes described herein, it may be taken that the ESD process occurs in the presence of a shielding gas, such as Argon.

As noted, power supply 50 includes an ESD power source positive terminal and an ESD power source negative terminal, one being connected to workpiece holder 40, and therefore to workpiece 20; and the other to applicator 24. In one example, applicator 24 is connected to the low power motor of oscillator 42 through a flexible shaft 43.

In the example, the apparatus is established such that the apparatus is capable of providing relative motion between welding head 24 and workpiece holder 40. Workpiece holder 40 may have six or more degrees of freedom (i.e., translation in the x, y and z direction, and rotation about the x, y, and z axes) and welding head 24 may similarly have those six degrees of freedom. Perhaps typically, workpiece holder 40 may have planar translational freed om of motion on the x and y axes, while welding head 24 has vertical translational freedom of motion in the z-direction to allow it to approach toward or draw away from workpiece 20.

There may be other degrees of freedom. In some instances, as for example where workpiece 20 is a body of revolution, workpiece holder 40 may have a rotational degree of freedom of motion about the z-axis to allow it to spin or rotate, as for example when a welding cap is mounted on a spinning mandrel. Moreover, the workpiece holder may be caused to vibrate, whether by having an oscillator, a rotating mechanical imbalance, an ultrasonic vibrator, and so on, with the vibration being driven in any one or more of the x, y and z directions. Further still, the welding head may be mounted to a robot, as shown and described in U.S. Pat. No. 11,077,516 of Scotchmer et al., which is incorporated herein by reference. Whether welding rod 28 is mounted to a robot or mounted to a hand-held applicator, the tool holder may also be subject to vibration, whether due to an oscillator, a rotating mechanical imbalance, an ultrasonic vibration generator and so on. To the extent that both the work piece holder and welding head vibrate, they may vibrate at different frequencies and in different directions or degrees of freedom. The vibration forcing function is superimposed on top of the translational motion of the workpiece holder or welding head as may be.

However it may be, non-conductive mask or masks 60 may be applied to areas of the surface of substrate 22 of work piece 20 to which it is not desired to apply a coating. By the very low power nature of ESD contacts, the masking may be made with masking tape, which itself is substantially electrically non-conductive. Whatever the geometry of the workpiece may be, whatever portion of it may be masked, and whether flat or contoured, once the dried slurry has been established on the surface to be treated, the process may proceed.

Moreover, use of an ESD coating may also allow a coating 30 to have a specific footprint sized and configured to match some mating object, or suitable for a particular purpose, as suggested by the shapes of the patterns of coating areas A₁ and A₂ of FIG. 3. Although two areas are shown, there may be many such areas, such as may correspond to contact regions of a second object and such other additional third, fourth, and so on, objects as may be. As indicated in FIG. 3, these footprints need not be purely rectangular, but may be have legs or portions that form extended shapes, such as a U-shape of footprint 54 or an S-shape of footprint 55. This permits coating 30 to be discontinuous, which is to say there may be a sub-region or plural regions of coating 30 (or coatings 30), such as first coated region A₁ and second coated region A₂. There may be a third coated region and such other coated regions as may be, that are separate and distinct from each other. For electrical or mechanical properties, it may be desired that the composition of respective coating 30 may be different for each of these various areas.

Furthermore, being an ESD coating, the thickness of coating 30 is determined by controlling the quantity of deposited materials. Coating 30 may include a first coating layer made of a first material, or first alloy, and a second coating layer or second coating alloy that may be of the same or a different material or different composition of matter. The first material (or alloy) may be compatible with the material of substrate 20. The second material (or alloy) may be compatible with the first material, and so on. Or it may be that successive layers of one material may be built up in increasing thickness by subsequent processing. Although reference is made to a first layer and a second layer, there may be more than two layers.

Welding electrode applicator 24 may be as shown and described in US patent application U.S. Ser. No. 15/856,146, of Huys Industries Ltd., published as US Publication 2018/0 178 308 A1 on Jun. 28, 2018, the specification and drawings thereof being incorporated in their entirety herein by reference. In each case, the welding electrode is sized to be suitable for access to and use with the surface in question.

A premise of ESD coating is that the work piece is, or work pieces are, electrically conductive, and connected to one terminal of a welding power supply 50. That is, a first terminal 62 of power supply 50 is connected by a conductor such as wire or cable to welding applicator 24. Terminal 64 is of opposite polarity to the terminal to 62. Whether directly or indirectly, substrate 20 and power supply 50 are in electrical connection to form a continuous path for electric current. Similarly, as noted, the other terminal of power supply 50 is connected to welding applicator 24 to form a continuous electrical path to welding rod 28 of opposite electrical polarity to work piece 20 such that an arc will be formed between them when they approach. During operation applicator 24 is subject to rotation or to an oscillation forcing function that causes it to vibrate, which in turn causes vibration of rod 28 against work piece 20, rapidly making and breaking contact therewith. This forcing function may be provided by a rotating mechanical imbalance, or it may be provided by an ultrasonic vibrator. In either case, the deposition process may include peening the coating with the end of the applicator rod when electricity is not being discharged, e.g., intermittently between discharges or after discharge during cooling to yield a finer grain structure and an even coating; and, additionally or alternatively, it may be shaken, as by induced vibration applied to substrate 20 either directly or through its jig to cause finer grain structure to form during cooling.

In some instances, coating 30 may a single layer, applied alone. However, in other instances, the process of depositing a layer of coating 30 includes a first step or portion of deposition, and a second step or portion of peening of the coating on surface 24. The peening process may tend to occur while the underlying metal is still hot, and therefore susceptible to plastic deformation. That plastic deformation due to peening tends to flatten asperities in the surface, and the resultant deformed, coated surface may tend to have a reduced tendency to develop crack initiation site.

During ESD, the tip of welding electrode rod 28 is in intermittent contact with the work surface, and that intermittent contact tends to have a mechanical hammering effect on the surface being coated. When electrical current is flowing, an arc will form and material of rod 28 will be deposited in a molten form on surface coating 30 The electric arc melts both a portion of welding rod 28 and a portion of covering 30 transforming that portion of covering 30 from its green state to its fused state. This occurs until the entire ESD process is completed. There will also be local heating due to the heat of the electric current discharge. Each electrical contact results in a low energy local discharge heating of, for example, less than 10 J. Typically the discharge at one point of contact is of the order of 1 J-2 J. When the electrical discharge current is turned off, the tip of electrode rod 20 may continue repeatedly to contact the surface according to the vibration forcing function as welding applicator 24 oscillates, without further material discharge occurring. This non-electrical discharge contact, when current is not flowing, provides the peening step. The electrical discharge step may involve the switching on and off of current over relatively short time periods on the order of one or two milliseconds. This switching is achieved with programmable power supply 50. Similarly, the time period when electrical discharge current is off may be quite short, again, of the order of one or two, or a few, milliseconds. The switching “On” and “Off” may occur rapidly and repeatedly such that while the steps of discharging and peening may be distinct, and cyclic, to a human observer it may appear that they are occurring at the same time, and that they are continuous.

In some instances, the ESD discharge coating and peening process may occur in a non-participating environment. That is, the process may be performed in a vacuum chamber or it may be performed in a chamber that has been flushed with a non-participating gas, such as an inert gas such as neon or argon, or a non-oxidizing gas, such as carbon dioxide.

In some instances, the coating may be deposited, and then the process of coating may be followed by mechanical peening while electrical discharge is not occurring. In other instances it may be deposited without mechanical peening. In either case the coating process, with or without peening, may be followed by one or more steps of post-process heat treatments. Depending on the nature of the alloy from which the work piece is formed, heat treatment may be employed to promote a precipitation hardening effect. While a separate peening tool could be used in some embodiments, it is convenient to use electrode rod 98 as the peening tool, with the electrical current interrupted.

More generally, it can be said that in its various embodiments and examples, the method of surface treatment being discussed herein may employ an electrically conductive material. That material is a metal alloy material. It may be applied to a metal, or metal alloy as suitable. It may be applied to weldable semi-conductor alloys or to weldable metal-based composites such as Titanium Carbide and Titanium di-Boride. It contemplates that the work piece in various embodiments is formed of a material that includes at least one of (a) Nickel; (b) Chromium; (c) Molybdenum; (d) Titanium; (c) Tungsten; (f) Iron (g) Steel (h) Aluminum and Aluminum alloys; and (i) Niobium; (j) Magnesium; and (k) Cobalt. The material may also include one or more of Carbon, Cobalt, Manganese, Vanadium, or other metals that may be found in steel alloys, Nickel-based alloys, Aluminum alloys or Copper alloys. In some cases, work piece 20 is made of a metal alloy of which Nickel, Chromium, and Iron are the largest constituents by wt. %. In some alloys it is more than 40% Nickel, and more than 10% Chromium, two constituents being the primary constituents of the alloy and forming a majority of the material.

In another example, the “green” powder may be established on the workpiece by brushing or painting or spraying on individual layers of powder of each of the components of the green mixture, one component at a time until all of the components are present, without pre-mixing the powders. The individual coatings themselves are thin, of the order of a few μm, such that the total thickness is comparable to the thickness that would have been obtained if the components had been mixed as powders before application in the green state to the work piece. The ESD welding process them provide low energy discharge contacts that weld and fuse the components of all of the deposited layers to the workpiece.

In the examples, the ESD coating material of rod 44 is formed of an alloy including at least one of (a) Nickel; and (b) Chromium. In some embodiments Nickel is, by wt. %, the largest component. In some examples, the material for deposition from the welding rod as the coating is formed of an alloy that includes at least one of (a) Nickel; (b) Chromium; (c) Iron; (d) Tungsten; (c) Cobalt; and (f) Titanium. In some instances the coating material is formed of an alloy that, by weight, has a higher percentage of Nickel than any other constituent. It may be nearly pure Nickel, i.e., more than 90% by weight. In other embodiments the coating material is made of a metal alloy of which Iron is the largest constituents by wt. %. In other embodiments the coating material is made of a metal alloy of which Cobalt is the largest constituents by wt. %. In still others the coating material is made of a metal alloy of which Titanium is the largest constituents by wt. %. Ultra high purity argon shielding gas can be delivered coaxially around the electrode during deposition, and ESD parameters of 100 V, 80 μF and 150 Hz can be used. The method could have an initial discharge voltage in the range of 30 to 200 V.

Once coating 30 has been applied, additional layers or sub-layers, may be added whether of the same composition or a different composition. These processes may be undertaken with relative control over the area and size of the weld, and of the total energy input in the weld. The total energy input may be set according to the surface area of the weld to be made, and the thickness of the material of the weld.

In operation, the output switching of power supply 50 is controlled by a main control unit of power supply 50. Although the synthetic DC electrical signals, or electrical pulses, however they may be called, may not have the same period or pulse duration, they may have an average rate of discharge, or an accumulated number of signals per elapsed unit of time. For example, there may be 10 to 10,000 signals, or discharges, over a period of 1 second. In some embodiments this rate may be in the range of 1500 discharges per second to 5000 discharges per second. This can be termed a frequency range of 10 Hz to 10 kHz, except that the individual pulses are not cyclic, but rather are discrete, programmed, DC discharges. The operator may program the power supply by adjusting the discharge voltage levels, and the overall energy discharge per unit time (effectively, the pulse voltage, total charge, and the number of pulses per second) to govern the overall heat input into the workpiece interface (e.g., to avoid over-heating). However, once having set those external input parameters, the main control unit is programmed electronically to implement the selections made by the operator.

The operator may also select whether straight polarity is to be employed, and to what extent. Alternatively, the deposition apparatus may sense the rate of consumption of the welding electrode, and, when that rate of consumption has fallen relative to the initial rate by a datum amount, such as ⅕ or ¼ (i.e., to ⅘ or ¾ of the original rate), to initiate a cleaning cycle using straight polarity. The cleaning cycle may include a series, or burst, of straight polarity pulses, or it may be implemented by alternating between forward or straight (i.e., cleaning) and reverse (i.e., deposition) pulses. The number of straight pulses may be different from, (i.e., not equal to), the number of reverse pulses. For example, the ratio of cleaning pulses to deposition pulses may be in the range of 1:1 to 1:10.

ESD operates by discharging a capacitor through a welding rod and work piece sheet, creating a short-duration arc that transfers droplets of material from the welding rod onto the work piece. With repeated capacitor discharge, the small droplets are layered to form thicker coatings. Due to the small droplet size and short pulse durations, heat input and heat buildup is limited, typically to 1 or 2 Joules per discharge, or less; and generally less than 10 Joules.

In respect of materials and methods, in the example commercially available welding rods of may be of relatively small diameter, such as 1.8 mm diameter. The ESD process parameters may be chosen to obtain the fastest deposition rate, e.g., of 310 μF and 140 V at 150 Hz frequency. Shielding gas may be used, such as ultra high purity argon gas applied coaxially with the welding rod at a flow rate of 10 L/min. Relatively high rates of deposition can be obtained with discharges in the range of 200-400 μF. The range of voltages observed to yield suitable rates of deposition was 100-160 V.

To summarize, the description relates to a method of applying a coating to a workpiece, and to the resultant ESD-welded material and treated workpiece. The method is a method of treatment of an electrically conductive work piece using Electro-Spark Discharge (ESD) welding. The method includes coating a first region of the workpiece with a powder composition of electrically conductive particles, the powder composition being in a green state; and using an ESD applicator to weld the composition to the workpiece.

In that method, as described, the method includes obtaining powders of at least a first material and a second material; mixing those powders together; and applying the mixture of powders to the workpiece. The method can include preparation of a High Entropy Alloy mixture. In each case, the method includes preparation of a powder mixture in which there are more than two principal elements. The method includes preparation of a powder mixture in which no element has an atomic fraction greater than 35%. (That is, the atomic fraction of each element is less than or equal to 35%.) The method can include preparation of a powder mixture of at least three elements, each of those elements having an atomic fraction of 5%-35%. The method can include preparation of a powder mixture of an alloy of at least five elements, and in which each of the at least five elements has an atomic fraction of 5-35%. The method includes forming the powder composition into a slurry. The method includes applying the slurry to the workpiece and allowing the slurry to dry on the workpiece in the green state prior to ESD processing.

Included in this description, in some examples the method includes combining the powder composition and a carrier. In some examples the carrier is an aqueous liquid. In another example, the carrier is a binder. The method includes applying the powder composition to the work piece and then allowing the binder to set. In another circumstance, the method includes depositing successive layers of green material on the workpiece.

The method contemplates that the ESD applicator employs a welding rod of a material that is different from the powder composition. It also contemplates that the ESD applicator employs a welding rod of a material that is different from the workpiece. In any such process, the method includes conducting ESD processing of the workpiece with electrical discharges of less than 10 Joules per contact. It may further include conducting ESD processing at an ESD contact frequency of 10 to 10,000 Hz. It may more narrowly include the contact frequency being in the range of 1500 to 5000 Hz. It also may include vibrating the workpiece during ESD processing independently of any vibration of the ESD applicator. Alternatively or additionally it may includes ultrasonic vibration of at least one of (a) the workpiece; and (b) the ESD applicator. The method may include peening one the powder composition has been changed from the green state to a welded (i.e., or fused) state.

The method may include reversing polarity of the workpiece and the ESD applicator. The method may include applying powder composition to more than one discrete surface areas of the workpiece. The method may include masking at least one portion of the workpiece. The method may include applying the powder mixture to a surface that is at least one of (a) not flat; and (b) not horizontal.

Various combinations have been shown, or described, or both. The features of the various embodiments may be mixed and matched as may be appropriate without the need for further description of all possible variations, combinations, and permutations of those features. The principles of the present invention are not limited to these specific examples that are given by way of illustration. It is possible to make other embodiments that employ the principles of the invention and that fall within its spirit and scope of the invention. Since changes in and or additions to the above-described embodiments may be made without departing from the nature, spirit or scope of the invention, the invention is not to be limited to those details, but only by the appended claims.

1. A method of treatment of an electrically conductive work piece using Electro-Spark Discharge (ESD) welding, that method comprising: coating a first region of the workpiece with a powder composition of electrically conductive particles, the powder composition being in a green state; and using an ESD applicator to weld the composition to the workpiece.

2. The method of claim 1 wherein the method includes obtaining powders of at least a first material and a second material; mixing those powders together; and applying the mixture of powders to the workpiece.

3. The method of claim 2 wherein the method includes preparation of a High Entropy Alloy mixture.

4. The method of claim 2 wherein the method includes preparation of a powder mixture in which there are more than two principal elements.

5. The method of claim 2 wherein the method includes preparation of a powder mixture in which no element has an atomic fraction greater than 35%.

6. The method of claim 2 wherein the method includes preparation of a powder mixture of at least three elements, each of those elements having an atomic fraction of 5%-35%.

7. The method of claim 2 wherein the method includes preparation of a powder mixture of an alloy of at least five elements, and in which each of the at least five elements has an atomic fraction of 5-35%.

8. The method of claim 1 wherein said method includes forming the powder composition into a slurry.

9. The method of claim 8 wherein the method includes allowing the slurry to dry on the workpiece in the green state prior to ESD processing.

10. The method of claim 1 wherein said method includes combining the powder composition and a carrier.

11. The method of claim 10 wherein the carrier is an aqueous liquid.

12. The method of claim 10 wherein the carrier is a binder.

13. The method of claim 12 wherein the method includes applying the powder composition to the work piece and then allowing the binder to set.

14. The method of claim 1 wherein the method includes depositing successive layers of green material on the workpiece.

15. The method of claim 1 wherein the ESD applicator employs a welding rod of a material that is different from the powder composition.

16. The method of claim 1 wherein the ESD applicator employs a welding rod of a material that is different from the workpiece.

17. The method of claim 1 wherein the method includes conducting ESD processing of the workpiece with electrical discharges of less than 10 Joules per contact.

18. The method of claim 1 wherein the method includes conducting ESD processing at an ESD contact frequency of 10 to 10,000 Hz.

19. The method of claim 18 wherein the frequency is in the range of 1500 to 5000 Hz.

20. The method of claim 1 wherein the method includes vibrating the workpiece during ESD processing independently of any vibration of the ESD applicator.

21. The method of claim 1 wherein the method includes ultrasonic vibration of at least one of (a) the workpiece; and (b) the ESD applicator.

22. The method of claim 1 wherein the method includes peening.

23. The method of claim 1 wherein the method includes reversing polarity of the workpiece and the ESD applicator.

24. The method of claim 1 wherein the method includes applying powder composition to more than one discrete surface areas of the workpiece.

25. The method of claim 1 wherein the method includes masking at least one portion of the workpiece.

26. The method of claim 1 wherein the method includes applying the powder mixture to a surface that is at least one of (a) not flat; and (b) not horizontal.
